(19) United States
(12) Patent Application Publication
(10) Pub. No.: US 2002/0103759 A1
(43) Pub. Date: Aug. 1, 2002

(54) Contents providing service system, server apparatus, and client apparatus

(76) Inventors: Shuichi Matsumoto, Hamamatsu-shi (JP); Takeshi Kikuchi, Hamamatsu-shi (JP)

Correspondence Address: HARNESS, DICKEY & PIERCE, P.L.C., P.O. BOX 828, BLOOMFIELD HILLS, MI, 48303, US

(21) Appl. No.: 10/036,120

(22) Filed: Dec. 26, 2001

(30) Foreign Application Priority Data
Dec. 26, 2000 (JP) P.2000-395702

(51) Int. Cl. G06F 17/60

(52) U.S. Cl. 705/51

(57) ABSTRACT

An encrypted contents file contains use restriction information, and contents. The use restriction information corresponds to such an information capable of restricting a use of the contents when the contents are used. A Web server provides the encrypted contents file to a client, and thereafter, transmits use approval information outputted from a use approving unit to the client in response to a request issued from this client. The use approving unit approves the use of the contents under such a condition that the client has paid a consideration of the use of the contents, and changes a use restriction of the contents provided to the client, so that the client can use the contents.

### BACKGROUND OF THE INVENTION

The present invention relates to a contents providing system, a sever apparatus, a contents providing method, a client apparatus, a contents utilizing method, and a recording medium on which a content utilizing program is recorded, which are for providing contents of music information and the like while a right holder thereof conditionally provides these contents.

Generally, such services are known in the field, i.e., various sorts of contents such as a music file and a musical performance file are provided from servers via networks.

There are many utilization modes of these contents depending on users. For instance, when music files are exemplified, the following utilization modes are available, namely, a sheet of music is merely viewed by being displayed on a display screen; a sheet of music is displayed and printed out; and a total printing time of music is only one time, or more than two times. On the other hand, depending on a right holder having copyright or the like for contents, one of these utilization modes may not allowed to use, for example, printing of the contents without limitation.

Accordingly, it is not a rational case that utilization items of contents are uniformly determined and/or use fees are evenly determined. Instead, the following case is rational. That is, utilization items and use fees are precisely set between users and right owners in accordance with the respective contents.

There is a further case that certain contents to be provided are constituted by a plurality of partial contents which are related to each other. For instance, in the case of music information of a certain program, a right holder as to this content wishes to combine musical performance data of this program with partial contents as one set, while these partial contents are related to the same program such as music and the words, but have different items to each other.

When these plural contents are provided as one set, such a user who wants to purchase these contents may accomplish a purchase procedure within one time, while this user need not seek the individual contents but also need not separately complete purchase procedures thereof.

However, there is another user who wants to purchase only a part of these plural contents. As a result, the following fee setting method is rational, as compared with such a fee setting method that contents are provided as one set and a user fee is set as to one set of these contents. That is, a use fee is set only to unit contents which the user wants to utilize.

There is a further case that after a user has once utilized contents, this user again wants to utilize the same contents. For instance, after a user has utilized the contents by way of a certain utilization mode (e.g., after music file is displayed), the user wants to utilize the contents by way of the same utilization mode by again paying the use fee, or wishes to utilize the contents by way of a different utilization mode, for example, a printing mode. Otherwise, the user wants to utilize another partial content, for example, user wishes to play music by utilizing a music file. In these cases, it is useless that the user completely downloads one set of these contents.

### SUMMARY OF THE INVENTION

The present invention has been made to solve the above-described problems, and therefore, has an object to provide such a contents providing service system capable of utilizing contents within a range in which a right holder of the contents allows to use these contents, and also capable of arbitrarily determining a use range of contents which are purchased. Furthermore, the present invention has another object to provide a server apparatus, contents supplying method, a client apparatus, a contents utilizing method, and a recording medium on which a contents utilization program is recorded.

In order to solve the aforesaid object, the invention is characterized by having the following arrangement.

1. A contents providing service system for providing a contents file from a server apparatus to a client apparatus, wherein:

the contents file corresponds to a file including contents and use restriction information which are encrypted, and the use restriction information indicates a use prohibit range of the contents, a use allow range of the contents and a provisional use prohibit range in which allowing a utilization of the contents file is conditional on a user fee payment;

the server apparatus includes a supply unit for supplying the contents file to the client apparatus; and

the client apparatus includes: a decode unit for decoding the contents and the use restriction information, which are contained in the contents file supplied from the server apparatus; and a contents use restriction unit for allowing a utilization of the contents based on the decoded use restriction information.

As a consequence, a user can utilize contents within a range which is allowed by a right holder of the contents, and can arbitrarily determine a use range of such contents which are purchased. The contents file can be previously supplied to a client. Concretely speaking, such a contents file may be supplied via a network, or may be recorded on a recording medium, and thereafter, may be supplied from a server apparatus to a client apparatus.

(2) A contents providing service system according to (1), wherein

the client apparatus includes a use request unit for transmitting, to the server apparatus, a use request for requesting a use of the contents contained in the provisional use prohibit range;

the server apparatus includes a use approve unit for transmitting a use approval to the client apparatus when a use fee responding to the use request is paid in response to the user request; and

the use restriction unit of the client apparatus allows to use the contents which are requested to be used in accordance with the use approval.

As a consequence, the user may arbitrarily determine the use range with respect to a use of contents contained in the provisional use prohibit item and then, may purchase the arbitrarily determined contents. In this case, the user need not again receive the supply of these contents.

(3) A server apparatus for supplying a contents file to a client apparatus, wherein

the contents file corresponds to a file including contents and use restriction information which are encrypted, and the use restriction information indicates a use prohibit range of the contents, a use allow range of the contents and a provisional use prohibit range in which allowing a utilization of the contents file is conditional on a user fee payment;

the server apparatus includes a supply unit for supplying the contents file to the client apparatus; and

the server apparatus allows the client apparatus to use the contents based on the use restriction information.

As a consequence, a user can utilize contents within a range which is allowed by a right holder of the contents, and can arbitrarily determine a use range of such contents which are purchased. The contents file can be previously supplied to a client. Concretely speaking, such a contents file may be supplied via a network, or may be recorded on a recording medium, and thereafter, may be supplied from a server apparatus to a client apparatus.

(4) The server apparatus according to (3), wherein

the contents include a plurality of partial contents which are mutually related to each other; and

the use restrict information represents the use prohibit ranges of the plurality of partial contents, the use allow ranges thereof, and the provisional use prohibit ranges thereof.

As a consequence, since the partial contents which are mutually related to each other are contained, such partial contents which are wanted by the user can be easily found out. The user may determine to purchase only such contents which are wanted to be used among a plurality of partial contents.

(5) The server apparatus according to (3) or (4), wherein

the contents include a plurality of representation modes; and

the use restriction information represents the use prohibit ranges of the plurality of representation modes, the use allow ranges thereof, and the provisional use prohibit ranges thereof.

As a result, since such contents, only representation modes of which are different from each other, are contained, contents having the user-desirable representation mode are selected from these contents, and then, the related contents may be purchased.

(6) The server apparatus according to any one of (3) to (5), wherein

the server apparatus includes a use approve unit for receiving a use request for requesting a use of the contents contained in the provisional use prohibit range from the client apparatus, and for transmitting a use approval to the client apparatus when a use fee responding to the use request is paid in response to the user request; and

the server apparatus allows the client apparatus to use the contents which are requested to be used in accordance with the use approval.

As a consequence, the user may arbitrarily determine the use range with respect to a use of contents contained in the provisional use prohibit item and then, may purchase the arbitrarily determined contents. In this case, the user need not again receive the supply of these contents.

(7) The server apparatus according to any of (3) to (6), wherein

the contents correspond to music information.

As a consequence, with respect to musical information having variations, use fees maybe precisely determined in accordance with utilizations of the users.

(8) A contents supplying method for providing a contents file from a server apparatus to a client apparatus, wherein the contents file corresponds to a file including contents and use restriction information which are encrypted, and the use restriction information indicates a use prohibit range of the contents, a use allow range of the contents and a provisional use prohibit range in which allowing a utilization of the contents file is conditional on a user fee payment, the contents supplying method comprising the steps of:

supplying the contents file to the client apparatus; and

allowing the client apparatus to use the contents based on the use restrict information.

As a consequence, a similar effect to that of the invention recited in (3) may be achieved.

(9) The contents supplying method according to (8), wherein

the contents include a plurality of partial contents which are mutually related to each other; and

the use restrict information represents the use prohibit ranges of the plurality of partial contents, the use allow ranges thereof, and the provisional use prohibit ranges thereof.

As a consequence, a similar effect to that of the invention recited in (4) may be achieved.

(10) The contents supplying method according to (8) or (9), wherein

the contents include a plurality of representation modes; and

the use restriction information represents the use prohibit ranges of the plurality of representation modes, the use allow ranges thereof, and the provisional use prohibit ranges thereof.

As a consequence, a similar effect to that of the invention recited in (5) may be achieved.

(11) The contents supplying method according to any one of (8) to (10), wherein the contents supplying method comprises the steps of:

receiving a use request for requesting a use of the contents contained in the provisional use prohibit range from the client apparatus;

transmitting a use approval to the client apparatus when a use fee responding to the use request is paid in response to the user request; and

allowing the client apparatus to use the contents which are requested to be used in accordance with the use approval.

As a consequence, a similar effect to that of the invention recited in (6) may be achieved.

(12) The contents supplying method according to any of (8) to (11), wherein

the contents correspond to music information.

As a consequence, a similar effect to that of the invention recited in (7) may be achieved.

(13) A client apparatus for utilizing a contents file supplied from a server apparatus, wherein

the contents file corresponds to a file including contents and use restriction information which are encrypted, and the use restriction information indicates a use prohibit range of the contents, a use allow range of the contents and a provisional use prohibit range in which allowing a utilization of the contents file is conditional on a user fee payment;

the client apparatus includes:

a decode unit for decoding the contents and the use restriction information, which are contained in the contents file supplied from the server apparatus; and

a contents use restriction unit for allowing a utilization of the contents based on the decoded use restriction information.

As a consequence, a user can utilize contents within a range which is allowed by a right holder of the contents, and can arbitrarily determine a use range of such contents which are purchased. The contents file can be previously supplied to a client. Concretely speaking, such a contents file may be supplied via a network, or may be recorded on a recording medium, and thereafter, may be supplied from a server apparatus to a client apparatus.

(14) The client apparatus according to (13), wherein

the contents include a plurality of partial contents which are mutually related to each other; and

the use restrict information represents the use prohibit ranges of the plurality of partial contents, the use allow ranges thereof, and the provisional use prohibit ranges thereof.

As a consequence, since the partial contents which are mutually related to each other are contained, such partial contents which are wanted by the user can be easily found out. The user may determine to purchase only such contents which are wanted to be used among a plurality of partial contents.

(15) The client apparatus according to (13) or (14), wherein

the contents include a plurality of representation modes; and

the use restriction information represents the use prohibit ranges of the plurality of representation modes, the use allow ranges thereof, and the provisional use prohibit ranges thereof.

As a result, since such contents, only representation modes of which are different from each other, are contained, contents having the user-desirable representation mode are selected from these contents, and then, the selected contents may be purchased.

(16)The client apparatus according to (13) to (15), wherein

the server apparatus includes a use approve unit for receiving a use request for requesting a use of the contents contained in the provisional use prohibit range from the client apparatus, and for transmitting a use approval to the client apparatus when a use fee responding to the use request is paid in response to the user request; and

the server apparatus allows the client apparatus to use the contents which are requested to be used in accordance with the use approval.

As a consequence, the user may arbitrarily determine the use range with respect to a use of contents contained in the provisional use prohibit item and then, may purchase the arbitrarily determined contents. In this case, the user need not again receive the supply of these contents.

(17)The client apparatus according to (13) to (16), wherein

the contents correspond to music information.

As a consequence, with respect to musical information having varieties, use fees may be precisely determined in accordance with utilizations of the users.

(18) A contents utilizing method for utilizing a contents file supplied from a server apparatus, wherein the contents file corresponds to a file including contents and use restriction information which are encrypted, and the use restriction information indicates a use prohibit range of the contents, a use allow range of the contents and a provisional use prohibit range in which allowing a utilization of the contents file is conditional on a user fee payment, the contents utilizing method comprising the steps of:

decoding the contents and the use restriction information, which are contained in the contents file supplied from the server apparatus; and

allowing a utilization of the contents based on the decoded use restriction information.

As a consequence, a similar effect to that of the invention recited in (13) may be achieved.

(19) The contents utilizing method according to (18), wherein

the contents include a plurality of partial contents which are mutually related to each other; and

the use restrict information represents the use prohibit ranges of the plurality of partial contents, the use allow ranges thereof, and the provisional use prohibit ranges thereof.

As a consequence, a similar effect to that of the invention recited in (14) may be achieved.

(20) The contents utilizing method according to (18) or (19), wherein

the contents include a plurality of representation modes; and

the use restriction information represents the use prohibit ranges of the plurality of representation modes, the use allow ranges thereof, and the provisional use prohibit ranges thereof.

As a consequence, a similar effect to that of the invention recited in (15) may be achieved.

(21)The contents utilizing method according to any one of (18) to (20), wherein the contents supplying method comprises the steps of:

receiving a use request for requesting a use of the contents contained in the provisional use prohibit range from the client apparatus;

transmitting a use approval to the client apparatus when a use fee responding to the use request is paid in response to the user request; and

allowing the client apparatus to use the contents which are requested to be used in accordance with the use approval.

As a consequence, a similar effect to that of the invention recited in (16) may be achieved.

(22) The contents utilizing method according to (18) to (21), wherein

the contents correspond to music information.

As a consequence, with respect to musical information having varieties, use fees may be precisely determined in accordance with utilizations of the users.

(23) A computer readable recording medium on which a contents utilizing program for utilizing a contents file supplied from a server apparatus is recorded, wherein the contents file corresponds to a file including contents and use restriction information which are encrypted, and the use restriction information indicates a use prohibit range of the contents, a use allow range of the contents and a provisional use prohibit range in which allowing a utilization of the contents file is conditional on a user fee payment, the contents utilizing program is used to cause a computer to execute the steps of:

decoding the contents and the use restriction information, which are contained in the contents file supplied from the server apparatus; and

allowing a utilization of the contents based on the decoded use restriction information.

As a consequence, since the contents utilizing program is installed in the computer, a similar effect to that of the invention recited in (13) maybe achieved.

(24) The computer readable recording medium according to (23), wherein

the contents include a plurality of partial contents which are mutually related to each other; and

the use restrict information represents the use prohibit ranges of the plurality of partial contents, the use allow ranges thereof, and the provisional use prohibit ranges thereof.

As a consequence, since the contents utilizing program is installed in the computer, a similar effect to that of the invention recited in (14) maybe achieved.

(25) The computer readable recording medium according to (23) or (24), wherein

the contents include a plurality of representation modes; and

the use restriction information represents the use prohibit ranges of the plurality of representation modes, the use allow ranges thereof, and the provisional use prohibit ranges thereof.

As a consequence, since the contents utilizing program is installed in the computer, a similar effect to that of the invention recited in (15) may be achieved.

(26) The computer readable recording medium according to anyone of (23) to (25), wherein the contents utilizing program is used to cause a computer to execute the steps of:

receiving a use request for requesting a use of the contents contained in the provisional use prohibit range from the client apparatus;

transmitting a use approval to the client apparatus when a use fee responding to the use request is paid in response to the user request; and

allowing the client apparatus to use the contents which are requested to be used in accordance with the use approval.

As a consequence, a similar effect to that of the invention recited in (16) may be achieved.

(27) The computer readable recording medium according to any of (23) to (26), wherein

the contents correspond to music information.

As a consequence, since the contents utilizing program is installed in the computer, a similar effect to that of the invention recited in (17) maybe achieved.

### BRIEF DESCRIPTION OF THE DRAWINGS

FIG. 1 is a system structural diagram for explaining an embodiment mode of the present invention.

FIG. 2 is a concept diagram for describing possibilities owned by contents.

FIGS. 3A and 3B are block diagrams for explaining both a use restriction and a use permission of contents, while music information is exemplified.

FIG. 4 is an explanatory diagram for indicating one example of a use restriction list with respect to one music program.

FIG. 5 is a flow chart for describing an operation example of an application program of a client 30 in one embodiment mode of the present invention.

FIGS. 6A and 6B is block diagrams for explaining both a use restriction and a use permission of contents, while map data is exemplified.

### DETAILED DESCRIPTION OF PREFERRED EMBODIMENTS

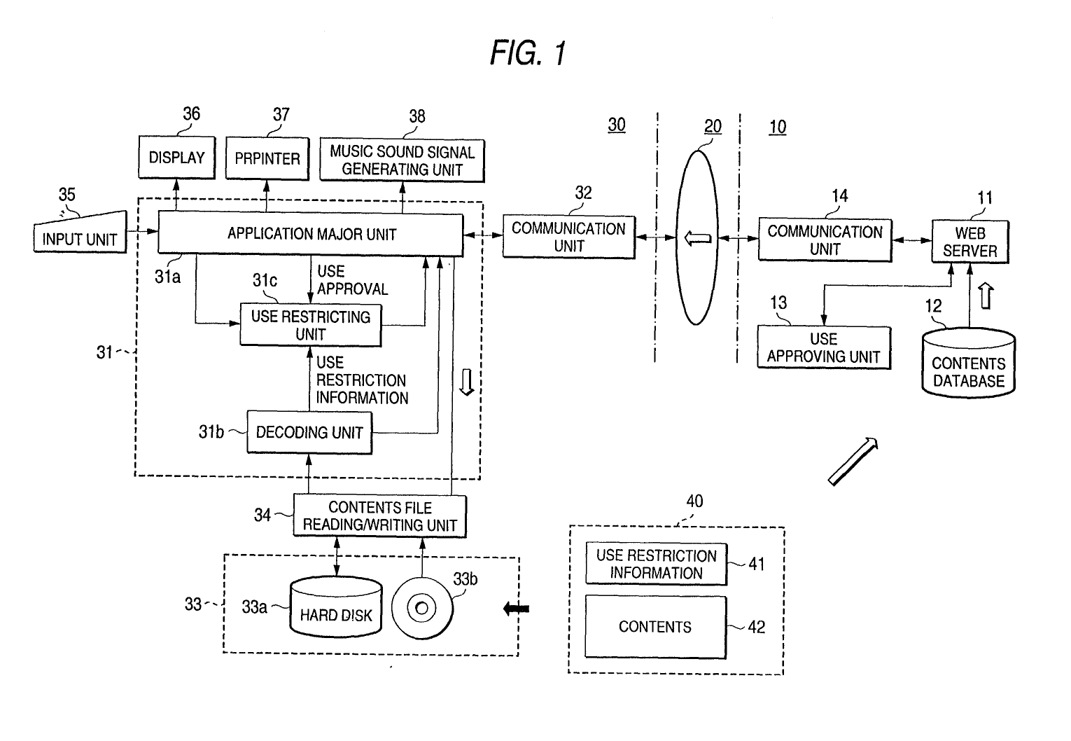

FIG. 1 is a system structural diagram for explaining an embodiment mode of the present invention.

In this drawing, reference numeral 10 indicates a server (service-distributing computer), and reference numeral 30 represents a client (service-distributed computer) . Reference numeral 20 shows a network in which the server 10 is connected via the Internet to the client 30 by employing a public telephone network, a communication-dedicated line, a LAN (local area network), and the like.

In the server 10, reference numeral 11 represents a Web server, reference numeral 12 shows a contents database, reference numeral 13 denotes a use approving unit, and reference numeral 14 indicates a communication unit.

The Web server 11 derives an encrypted contents file 40 from the contents database 12 in response to a request, or a demand issued from the client 30, and then, supplies the derived encrypted contents file 40 via the communication unit 14 and the network 20 to the client 30.

This encrypted contents file 40 contains use restrict information 41, and contents 42.

The contents database 12 contains a storage apparatus having a large storage capacity such as a hard disk unit (not shown), and stores thereinto a large number of contents.

While “music information” is exemplified as the contents 42, a description will now be made. The contents 42 are constituted by either one piece or plural pieces of encrypted “music information.” As the above-explained “music information”, there are “musical performance file (MIDI file and WAVE file)” of a certain program, and “music file (image file)” thereof. In the case that the contents 42 are arranged by a plurality of such partial contents, the plural partial contents may be encrypted, instead of another case that the entire contents are encrypted in a batch mode.

The use restriction information 41 corresponds to such information capable of restricting a use of the contents 42 when the contents 42 are utilized by the client 30. Either a right holder or a contents provider sets this use restriction information 41 by using a use approving unit 13 (will be discussed later) The use restriction information 41 is formed and encrypted in the contents database 12.

Alternatively, a plurality of contents 42 and the use restriction information 41, before being encrypted, may be stored into the contents database 12. For the sake of simple explanations, the below-mentioned description is made of the following case. That is, the use restriction information 41 is combined with such contents 42 which are not encrypted, and the combined contents are encrypted.

After the Web server 11 provides the encrypted contents file 40 to the client 30, this Web server 11 transmits a use approval outputted from the use approving unit 13 via both the communication unit 14 and the network 20 to the client 30.

As previously explained, the use approving unit 13 may approve a use of the contents 42, and may change the use restriction of the contents 42 provided to the client 30, so that the contents 42 may be utilized, under such a condition that the use restriction information is set by either a right holder of the contents 42 or a contents provider, and further, the client 30 has paid a consideration of the use of the contents 42.

In such a case that the client 30 has paid in advance a consideration of the use of the contents 42, the use approving unit 13 may previously set/change the use restriction information 41 into such a use restriction responding to this consideration, and thereafter, the server 10 may provide the encrypted contents file 40 to the client 30.

Next, in the client 30, reference numeral 31 shows a function block of an application (application program), and reference numeral 32 indicates a communication unit. Reference numeral 33 denotes a contents file storage unit. This contents file storage unit corresponds to such a hard disk 33a which is built in the client 30, or such a portable storage unit as a CD-ROM (Compact Disk-Read Only Memory) 33b. There are a readable/writable recording medium such as the hard disk 33a, and a read-only recording medium such as the CD-ROM 33b. Reference numeral 34 shows a contents file reading/writing unit, reference numeral 35 indicates an input unit, reference numeral 36 shows a display, reference numeral 37 indicates a printer, and reference numeral 38 indicates a music sound signal generating unit.

The function block 31 of the application indicates such a function which is realized by an application program which is operated on an OS (operating system) of a personal computer.

The function block 31 of this application may be executed by, for example, a “Web browser” program, a “helper application” program, or a “plug-in” program. The “helper application” program processes the encrypted contents file 40 independent from the “Web browser” program, instead of this Web browser program. The “plug-in” program processes the encrypted contents file 40 in conjunction with the Web browser program.

The application function block 31 may cause a Web page image having an HTML (Hyper Text Marking Language) format which is transmitted from the server 10 to be displayed on the display 36, or to be printed out by the printer 37. The application function block 31 may cause a demand to be transmitted to the server 10, and this demand is entered from the input unit 35, while a user views a display screen of the display 36. Furthermore, musical performance data used in streaming reproducing operation is outputted by the music sound signal generating unit 38 under control of the application function block 31.

In addition, the application function block 31 may receive the encrypted contents file 40, may display the contents 42 contained in this encrypted contents file 40 on the display 36, or may print out the contents 42 by the printer 37, or may streaming-play the contents 42 by the music sound signal generating unit 38.

In the function block 31 of the application, reference numeral 31a shows an application major unit, reference numeral 31b shows a decoding (decrypting) unit, and reference numeral 31c represents a use restricting unit.

The application major unit 31a downloads the encrypted contents file 40 transmitted from the server 10 via the contents file reading/writing unit 34 into, for example, the hard disk 33a of the contents file storage unit 33.

The contents file reading/writing unit 34 reads out the encrypted contents file 40 from the hard disk 33a to output this read contents file 40 to the decoding unit 31b. The decoding unit 31b decodes encryption by employing such a key which is used to decrypt an encrypted contents file so as to be separated into both the use restriction information 41 and the contents 42. Then, the decoding unit 31b outputs the use restriction information 41 to the use restricting unit 31c, and outputs the contents 42 to the application major unit 31a.

In view of a software idea, while both a contents memory area and a use restriction information memory area are allocated to a RAM (Random Access Memory) (not shown) provided in the application function block 31, both the contents 42 and the use restriction information 41 are stored into the predetermined memory areas, respectively.

In this embodiment mode, the key used to decrypt the encrypted contents file 40 may be acquired by way of any kinds of means. For instance, such a decrypt key may be previously distributed from the side of server 10 to the client 30 which cannot know this key distribution method. Alternatively, such a decrypt key may be previously stored in an application program irrespective of a use request issued from the client 30.

In the case that a certain contents use request is issued from the input unit 35 via the application major unit 31a, the use restricting unit 31c judges as to whether or not this use request is restricted based on the use restriction information. When this use request is not restricted, the use restricting unit 31c causes the application major unit 31a to use the contents 42.

Conversely, when the use request is restricted, the use restricting unit 31c may cause the application major unit 31a not to use the contents 42, and notifies such a fact that the use of the contents 42 is restricted with respect to a user of the client 30. In the case that the user of the client 30 again issues a use request, the use restricting unit 31c may cause the application major unit 31a to execute such a process operation that the application major unit 31a accesses the server 10, and then may use the contents 42 which are requested to be used.

The server 10 judges as to whether or not the use restriction of these contents 42 can be released in response to the use request of the contents 42 issued from the client 30. In the case that the contents are not set to be usable by the right holder, the use restricting unit 31c notifies such a fact that releasing of the use restriction of these contents 42 is not allowed to the user.

To the contrary, in the case that the contents 42 are set to be usable, the server 10 executes a charging process operation in response to the use request of the contents 42 issued from the client 30.

When a settlement is completed by that the user of the client 30 pays a consideration, the use approving unit 13 transmits a use approval via the communication unit 14 and the network 20 to the user restricting unit 31c. This use approval is used to allow a change of the user restriction.

The use restricting unit 31c which receives the use approval supplies an instruction capable of allowing the use of the contents 42 to the application major unit 31a by performing such a method for rewriting contents stored in the use restriction information memory provided on the RAM (not shown).

It should be noted that use restriction information may be restricted even as to the same contents 42 in response to various use modes, for example, a display by the display 26, and a print by the printer 37. In such a case, for example, while a capable flag (for example, displayable flag and printable flag) is employed, the use restriction information may be outputted to the application major unit 31a so as to instruct the relevant available work. In the application major unit 31a, when the state of this capable flag is “not allowed”, a display program portion and/or a print program portion may not be operable.

In the case that a total use time of contents is previously set as the use restriction information, the use restricting unit 31c counts a present use time, and then, stores this counted value into such a storage unit whose storage content is not deleted when a power supply is turned OFF, for example, the hard disk 33a.

In the case that the contents 42 are constituted by a plurality of partial contents, use restrictions may be separately set every partial content. In this case, the use restricting unit 31c judges as to whether or not each of these partial contents may be used, and then, outputs only such a partial content which is judged as the usable partial content to the application major unit 31a.

In the case that the respective partial contents are separately encrypted, only such a partial content which is judged as the usable partial content in the use restricting unit 31c may be decoded by the decoding unit 31b, and the decoded partial content may be outputted to the application major unit 31a. With employment of such a method, the capability may be improved which can avoid an unfair use of such partial contents which are not allowed to be used.

In the case that since the user of the client 30 accesses the server 10, the use mode which is approved in this manner is continuously used, the use restriction information 41 may be stored into such a storage unit whose content is not deleted when the power supply is turned OFF, for instance, the hard disk 33.

At this time, in the case that both the use restriction information 41 and the contents 42 are encrypted in an integral form such as the encrypted contents 40, the use restriction information 41 may be encrypted in combination with the contents 42 stored in the contents memory, and then, may be stored as a contents file. Alternatively, while only the rewritten use restriction information 41 is encrypted to be stored in the hard disk 33 and the like, the use restricting unit 31c may be controlled in such a manner that when the use restricting unit 31c refers to the use restriction information, this use restricting unit 31c may process the rewritten use restriction information 42 with a top priority rather than such use restriction information stored in the original contents file.

In the above-described explanation, the encrypted contents file 40 is downloaded from the server 10 via the network 20 to the client 30, but the present invention is not limited thereto.

Alternatively, while the encrypted contents file 40 is recorded on the recording medium such as the CD-ROM 33b in the server 10, this CD-ROM 33b may be supplied to the client 30 in the form of a consideration payment, or a free payment as a postal mail, a home delivery product, an appendix of a magazine, or an attached disk of a hardware product. In this alternative case, even when the CD-ROM 33b is not formed in the site of the server 10, the server 10may essentially supply the encrypted contents file 40.

When the user loads this CD-ROM 33b on a computer of the client 30 and then reads this loaded CD-ROM by using the contents file reading/writing unit 34, the use of the contents 42 may be restricted and the use of the contents 42 may be approved similar to the supply of the encrypted contents file via the network 20. In this case, the encrypted contents file 40 may be firstly copied from the CD-ROM 33b into the hard disk 33a so as to be subsequently used.

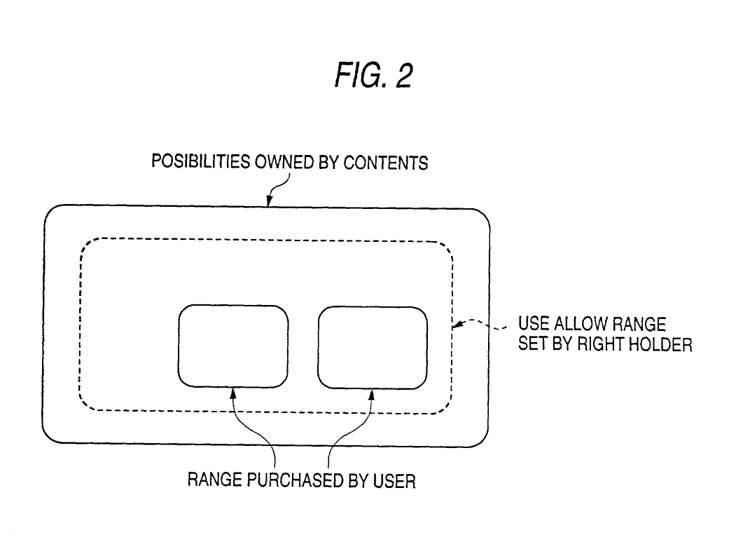

FIG. 2 is a conceptional view for explaining a possibility owned by contents.

In general, there are many possibilities owned by contents over a wide range, and there are various utilization modes. Among these possibilities, there is either a use allow range with a consideration payment or a use allow range with a free payment (no payment) which are set by a right holder having a copyright and the like. This use range is determined based on an intention of a right holder. Furthermore, within this use range with a consideration payment, a range of a purchase is determined based on an intention of a user.

In this embodiment mode of the present invention, as to a contents file supplied to the client 30, the following assumption is made. That is, all of use allow ranges indicated in FIG. 2 are supplied as the contents 42, or all of possibility ranges owned by contents are supplied to the client 30. In other words, setting of use restriction information is carried out within a usable range supplied to the content file.

A user of the client 30 determines a range for a purchase from a use allow range of the contents 42 which is downloaded to the hard disk 33a, or is recorded on the CD-ROM 33b to be supplied, and this user uses the determined contents by paying a fee. As to the contents 42, all of use allow ranges may be used as a consideration payment, and/or a portion of these use allow ranges may be used as a free payment. In such a case that the user of the client 30 utilizes a use allow range other than the set use allow range, the user accesses the server 10 at this time, and receives a use approval after the user has paid a use fee, so that the user is allowed to use the contents within this use allow range. Otherwise, before the encrypted contents file 40 is downloaded, the user of the client 30 pays a use fee of a range for purchase, and may receive the supply of the encrypted contents file 40 after the use restriction information has been rewritten in correspondence with this fee payment.

Alternatively, in the case that the contents 42 are supplied from the CD-ROM 33b, while the user of the client 30 may pay a use fee with respect to a portion of utilization when the CD-ROM 33b is purchased, this user may access the server 10 so as to receive a use approval by paying a use fee as to an optical contents use.

FIG. 2 is a block diagram for schematically explaining a use restriction of contents, namely a use permission, while music information is exemplified.

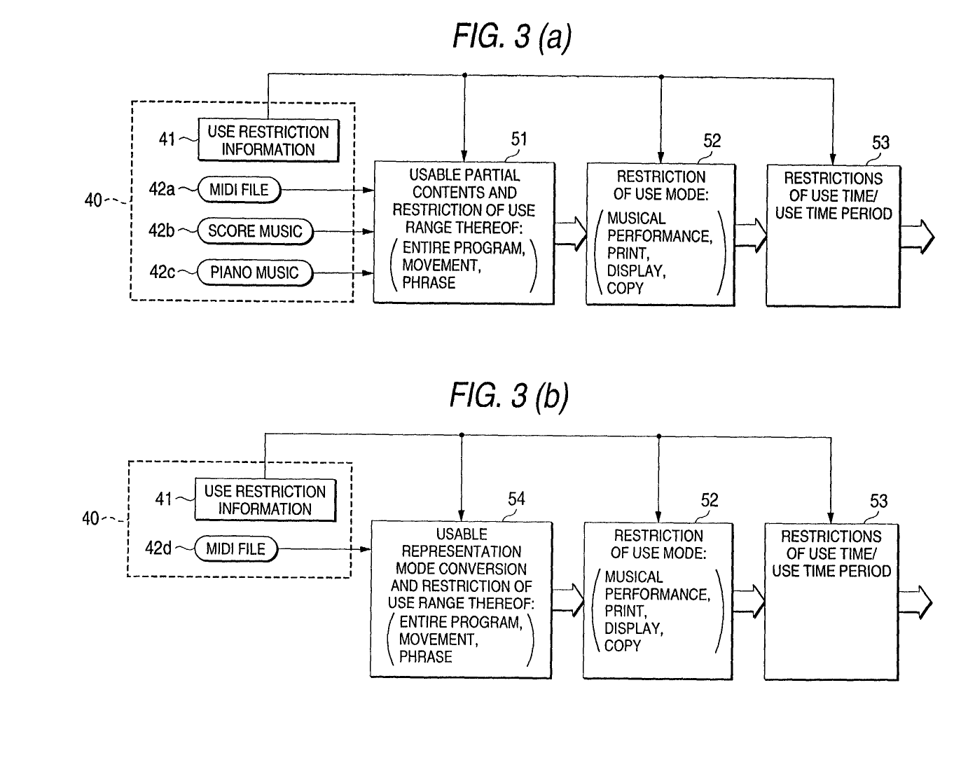

FIG. 3A indicates such a case that the contents 42 are actually constituted by a plurality of partial contents. In this example, the contents 42 is arranged by a MIDI file 42a, a score music file 42b, and a piano music file 42c.

Blocks 51 to 53 of this drawing describe use restrictions of different categories. These respective blocks are provided independent from each other. There are some cases that uses of these categories are not restricted in the respective blocks.

First, the block 51 restricts both a partial content and the use range thereof among three partial contents 42a to 42c.

With respect to each of the three partial contents 42a to 42c, the block 51 restricts the use ranges thereof in a separation manner. A use range implies such use ranges as an entire program (all parts of one program) a music part (specific music part), and a phrase (specific phrase) in such a case that a single music program is subdivided based on time progress (time elapse). When a use range is not restricted, a use range corresponds to an entire program. As explained above, in order to restrict a use range, comments data may be constructed in such a manner that music parts and phrases are discriminatable. Alternatively, it may be possible to provide such contents that an entire program is subdivided into music parts and phases. Alternatively, the above-described contents data may be combined with each other within these use ranges, and then, the combined contents data may be utilized.

There are many cases that a music program contains a plurality of parts. A use range of this part may be restricted. In particular, since a MIDI file may be separated every part thereof, a use of all of these parts of this MIDI file may be allowed. Furthermore, a melody part of this MIDI file may be restricted, both an accompaniment part and a rhythm part may be restricted, and a part of a specific musical instrument may be restricted. Apparently, while a plurality of parts may be combined with each other, a use of the combined parts may be allowed.

In the block 52, use mode restrictions are independently carried out with respect to the respective partial contents. In this case, a use mode corresponds to a play mode, a print mode, a display mode, and the like. It should be noted that copying of a decoded partial content into the hard disk 33a and the like corresponds to one of the use modes. As described above, such a use mode is restricted based on a use mode by a user, but this use mode does not intend to change a content itself.

This use mode may be furthermore subdivided, and the subdivided use modes may be defined based on a restriction and a permission. For instance, this use mode may be restricted as follows. When a sheet of music is displayed, a display screen size is restricted. When a sheet of music is printed out, resolution is restricted.

In the case that a MIDI file is utilized in a music play, with respect to a direct play of the MIDI file, the bellow-mentioned use modes imply one sort of use modes. That is, a user is allowed to change a musical instrument, to change a tempo, to change a tone and a musical interval, and to change a rhythm pattern.

In the block 53, with respect to the respective partial contents, use times and use terms are independently restricted. For example, the use modes correspond to a total printing time, and a playable time period.

On the other hand, FIG. 3B indicates such a case that even if there is only one content itself, when this content is used, then this single content may be utilized as such a content having different sorts of use modes.

Assuming now that the contents 42 are only such a MIDI file 42d as indicated in FIG. 3B, a usable representation mode may be converted in a block 54. The contents whose representation mode is converted may constitute such contents that information providing methods thereof are different with respect to a user. For instance, a MIDI file is used in a musical performance mode for attentioning to a hearing sense. However, the medium of this MIDI file may be converted into a music file for attentioning to a visible sense by executing an application program, and then, such a medium-converted file may be displayed, and/or printed out. As a result, even when the music file itself is not supplied as the partial contents, this music file may be supplied while the representation mode thereof is changed. It is so conceivable that the case of FIG. 3A involves the partial contents whose representation modes are different from each other as the original partial contents.

In the above-explained descriptions, the media conversion is employed as the representation mode conversion, but the present invention is not limited thereto. For instance, in an application program, such a phrase which can be hardly played may be edited from a MIDI file designed for a high-leveled player into a simple phrase; a tone of this MIDI file may be shifted to a C major key, so that this MIDI file designed for the high-leveled player may be converted into a MIDI file designed for a beginner player. With employment of this conversion, since the original contents may be converted into such contents which may be adapted to musical performance levels of users, the converted contents may be suitably supplied to these users.

In this block 54, similar to the block 51 of FIG. 3B, with respect to a plurality of contents which are newly formed by converting the plural representation modes, use ranges thereof may be independently restricted.

The blocks 52 and 53 are similar to those of FIG. 3B. That is, with respect to each of contents which are newly formed by converting the plural representation modes, a use mode may be restricted, and a total use time and a use time period may be restricted.

It should be understood that the above-described encrypted contents files 40 having the formats shown in FIG. 3A and FIG. 3B are not different from each other. For example, the following case maybe conceived. That is, the MIDI file 42a corresponding to one of the partial contents shown in FIG. 3A may be converted into such plural contents as shown in FIG. 3B, the usable representation modes of which are different from each other.

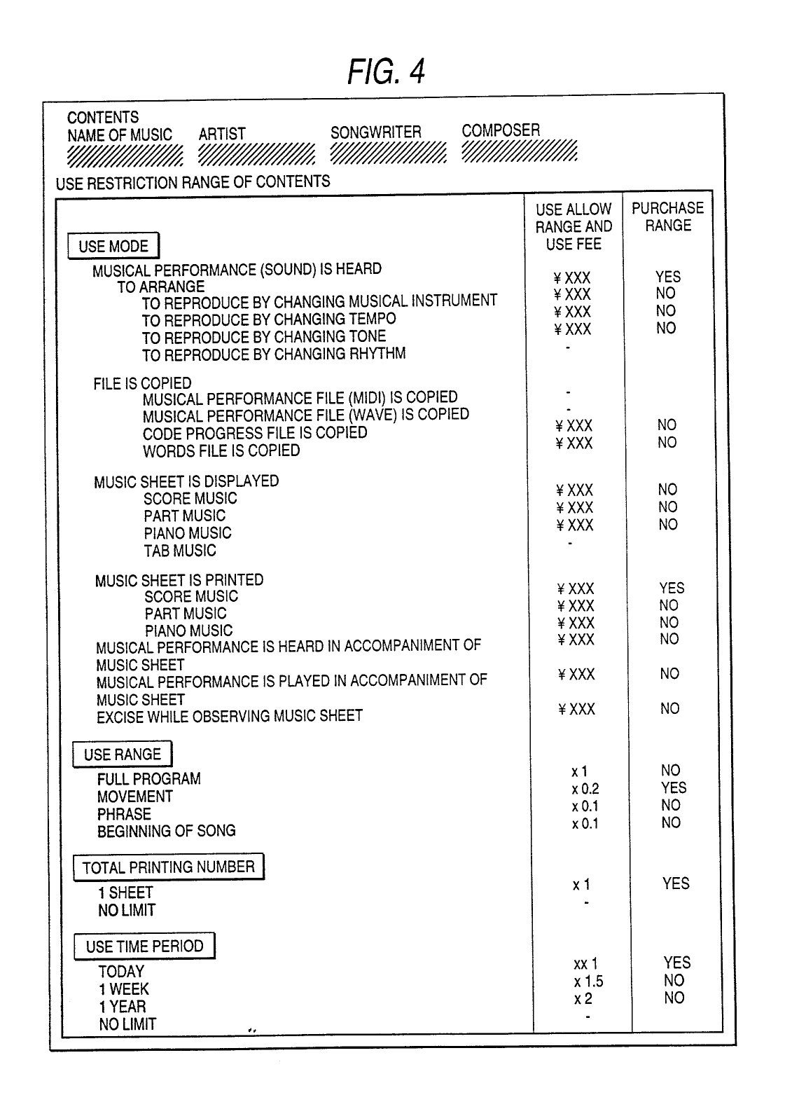

FIG. 4 is an explanatory diagram for explaining one example of a use restriction list with respect to one music program.

This use restriction list is arranged as a profile display screen of a single music program. In an upper stage of this use restriction list, there are indicated: a name of this music program, a name of an artist (either name of singer or name of musical performance), a name of a songwriter, and a name of a composer.

Since this use restriction list is intended to explain the embodiment mode of the present invention, a detailed restriction list is made. The use restriction items are listed up, while the contents 42 are employed as an initial condition. The contents 42 contain contents (for all programs which are separatable up to phrases) of music files which own the MIDI file 42a shown in FIG. 3A, and partial contents (for all programs which are separatable up to phrases) of waveform data, score music, part music, piano music, and tab music as individual partial contents.

Apparently, as indicated in FIG. 3B, image data of music may be produced form one piece of MIDI file 42d. Since the digital waveforms of the musical sound signal played in the musical sound signal generating unit 38 shown in FIG. 1 correspond to waveform data, a file having a WAVE format may be copied to the hard disk 33a by storing the waveform data.

In the example shown in this drawing, as the use mode, the following items are listed up: “musical performance is heard”, “file is copied” “music sheet is displayed”, and “music sheet is printed.” Application use modes are listed up. While “music sheet display” and “musical performance” are utilized at the same time, such an item “musical performance is heard in accompaniment of music sheet” is set. Such an item “play music in accompaniment of music sheet” is set by which “music sheet display” and “music performance by user” are allowed. Such an item “excise while observing music sheet” is set, by which “music sheet display” and “musical performance excise by user.” In this case, the expression “excise” implies that a specific part such as a melody part is automatically played, and a depression key guide lamp is turned ON based on musical performance data of this part. The two latter items correspond to such items which are utilized in a case that the client 30 is an electronic musical instrument equipped with a keyboard.

With respect to the respective use modes, there are provided such items for defining precise use items. In a use item of “musical performance (sound) is heard” (which involves not only musical instrument performance, but voice such as vocal and narration), such a use item of “to arrange” is set, under which use items provided for an application software side which utilizes the following contents are set. That is, these contents are defined as follows: “reproduce by changing musical instrument”, “reproduce by changing tempo”, “reproduce by changing tone”, and “reproduce by changing rhythm pattern.”

As a use item of “file is copied”, such an item of a file format which can be copied is set to the hard disk 33a. In this use item, the following files are indicated: a musical performance file using a MIDI code, a musical performance file of WAVE (waveform) data, a musical performance file of code progress (musical performance data of code part), and a musical performance file constructed only of a musical performance file of words (words (lyric) meta event ????? of KARAOKE musical performance data).

As precise use items of “music sheet is displayed” and “music sheet is printed”, there are provided “score music”, “piano music”, and “tab music.”

As to “use range”, there are such precise items as “full movements”, “movement”, and “phrase”, which are omitted in this drawing. These precise items specify a movement and a phrase in a concrete manner. Otherwise, this precise item may specify “beginning of song ?????.”

As a precise item of “music sheet is printed”, there are provided “one sheet” and “no limit.” As a precise use item of “use term”, there are provided “today”, “one week”, “one year”, and “no limit.”

In a second column of “use allow range and use fee”, a hyphen “-” is displayed in the case that a use item indicated in a first column is not set to a “usable” state by a right holder, whereas a price is displayed in the case that a use item indicated in the first column is set to the “usable” state by the right holder.

In rows of “use range”, “printing number”, and “use term”, multiplication rates are displayed. That is to say, when “use mode” is purchased, a coefficient which is multiplied with its price is indicated.

In a “purchase range” of a third column, “yes” is displayed in such a case that a use item indicated in the first column is set to a “purchase” state, whereas “no” is displayed in such a case that a use item indicated in the first column is set to a “non-purchase” state. Since a use item indicated as “no” is allowed under such a condition that a use fee is paid, this use item may be conceived as “provisional use prohibit item.” It should be noted that when there is a free-payment use item, “yes” may be displayed in a similar manner to the use item of “purchase.”

The above-described use restriction list may be displayed on the display 36 shown in FIG. 1, and may be printed out by the printer 37. This use restriction list is formed in such a manner that data of the use restriction item 41 is entered, or written into a template having a predetermined display format.

In the example of this drawing, the hyphen is displayed on the use item of the second column, which is not allowed to be used by the right holder. Alternatively, such an item which is not allowed to be used by the right holder may be omitted from the use restriction list displayed on the screen.

Subsequently, in the function block 31 of the application, only such an item whose use is allowed may be allowed to be used among the use restriction list. A provisional use prohibit item which is allowed to be used under such a condition that a use fee is paid corresponds to such an item which may be allowed when a use request is issued from a user. Other use items than this provisional use prohibit item may be regarded as such use items which are not allowed to be used by a right holder, while involving a use item which is not clearly displayed. As a consequence, the use item which is not allowed to be used by the right holder may be excluded from the use restriction information 41.

In the example of this drawing, as the encrypted contents file 40, the musical performance data, the music sheet, and the words are exemplified as the partial contents, which are mutually related to each other because of one same music program. As other partial contents, there are provided: a description sentence of this music program, a photograph of an artist, a promotion video tape, and a call receiving melody exclusively used for a portable telephone. Even when musical performance files using the same MIDI data are employed, since plural different sorts (standards) of data are present, musical files may be provided as partial contents with respect to each of plural data sorts.

As to other examples, as the mutual relationship, a plurality of music programs may be contained as follows: An art work collection of a specific artist, an excise program collection for class, or complete works of a certain category.

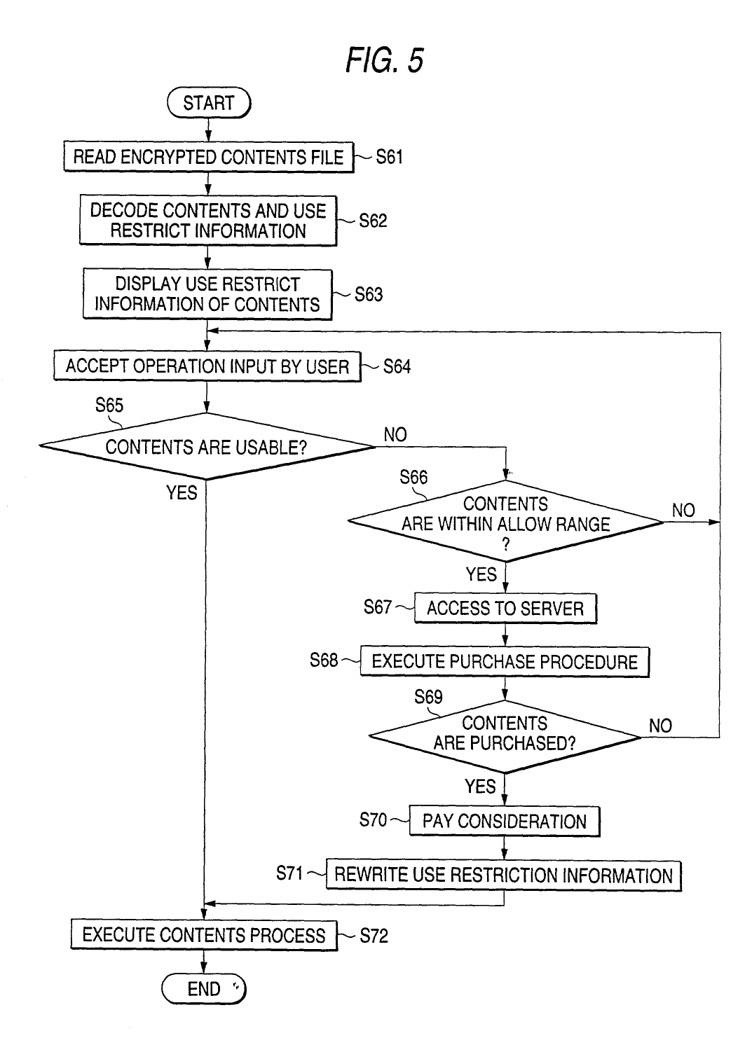

FIG. 5 is a flow chart for explaining an operation example of an application program of the client 30 according to an embodiment mode of the present invention.

This flow operation is started when the encrypted contents file 40 shown in FIG. 1 is supplied to the client 30. Otherwise, this flow operation is commenced in such a case that a user selects one encrypted contents file 40 from one, or a plurality of encrypted contents files 40 which are stored in the hard disk 33a.

At a step S61 of this flow chat, the encrypted contents file 40 is read, and then, this encrypted contents file 40 is decoded, or decrypted at a step S62. At a step S63, the use restriction information 41 of the contents 42 contained in the read encrypted contents file 40 is displayed. For example, the use restriction list shown in FIG. 4 is displayed on the display 36.

It should be noted that the use restriction list need not be always indicated. Alternatively, such an indication of “command” or “button” present in “menu”, or “tool bar” on a window screen may be previously displayed in a different display mode in response to a click input operation by manipulating a mouse with respect to “use prohibit item whose use is not allowed by right holder”, and “provisional use prohibit item whose use is allowed under such condition that use fee is paid.” This different display mode may be realized by, for example, a grey indication, which is different from that of “use allow item.” An input operation of an item whose use is not allowed to a user cannot be accepted. However, in the case of “provisional use prohibit item whose use is allowed under condition that use fee is paid”, the process operation may be advanced to a process operation such that the client accesses the server.

At a step S64, the process operation waits for an operation input by the user. When the operation input is made by the user, this process operation is advanced to a further step S65. At this step S65, a check is made as to whether or not the use of such contents which are specified by the input operation by the user is allowed with reference to the use restriction information.

When such an operation for instructing the execution of “use mode” in “yes” is made in “purchase range” of the use restriction list of FIG. 4, it is so judged that this item can be utilized. Then, the process operation is advanced to a step S72. At this step S72, process operations such as printing operation, display operation, and musical performance are carried out in response to the user input operation.

When the use of the item is not allowed at the step S65, the process operation is advanced to a further step S66. At this step S66, another check is made as to whether or not this item corresponds to the allow range by the right holder. If this item does not correspond to such a use item (“yes”) for instructing the execution in the use item indicated by the hyphen within “use allow range” of the use restriction list shown in FIG. 4, then the process operation is advanced to a step S67. To the contrary, when this item corresponds to such a use item (“no”) for instructing is the execution in the use item indicated by the hyphen, the process operation is returned to the previous step s64.

At the step S67, the client 30 accesses the server 10. An URL (Uniform Resource Locator) of the server may be described in a header portion (not shown) of the encrypted contents file 40, or may be described into the use restriction information 41. Since such an ID code for specifying the encrypted contents file 40 is contained in this URL, the client 30 may access the server 10, so that various procedures for using/purchasing this encrypted contents file 40 can be carried out.

At a step S68, the various procedures for purchasing the encrypted contents file 40 are executed. For example, an identification procedure for identifying an authorized user is carried out with respect to the server 10. Next, while use restriction information is transmitted from the client 30, the server 10 refers to this use restriction information. Alternatively, the use restriction information may be saved in the server 10. Next, such a Web display screen is transmitted to the client 30 in order that the user of the client 30 enters a use item, and then, this Web display screen is displayed on the display 36. The Web display screen prompts the user to input a request for purchasing a use of contents.

At a step S69, a judgement is made as to whether or not the user requests to purchase the utilization of the contents. When the user does not issue the purchase request (“no”), the process operation is returned to the previous step S64. To the contrary, when the user issues the purchase request (“yes”), the process operation is advanced to a further step S70.

At this step S70, the user pays a consideration so as to use the contents. Then, a process operation is transferred to either a charging server (not shown) which is installed on the site of the server 10 shown in FIG. 1 or another charging server which is operated by a bank and a credit firm located on another site over the network 20.

This charging server executes a charging process operation with respect to the user of the client 30. This charging process operation may be carried out in accordance with the well-known charging manner. For instance, this charging process operation may be carried out based on a settlement with employment of both a credit card number and a code number, or another settlement with employment of a card number described on a prepaid card.

When the settlement procedure is accomplished, the process operation is returned to the Web server 11, and then, the process operation is advanced to a step S71. At this step S71, the user restriction information is rewritten by the use approving unit 13 of the server 10, and then, the process operation is advanced to a further step S72. At this step S72, such a process operation whose use is restricted is carried out.

A use item whose use is allowed corresponds to such a use item which is continuously used, for example, a use time period is set to 1 week. In this case, as previously described, the rewritten use restriction information is encrypted, and then, the encrypted use restriction information is stored into a not-deletable recording medium.

In such a case that the encrypted contents file 40 is supplied by employing the CD-ROM 33b and this encrypted contents file 40 is used under such a condition that this encrypted contents file 40 is not copied to the hard disk 33a, the use restriction information stored in the CD-ROM 33b cannot be rewritten. In this case, while a storage area into which only the use restriction information is encrypted and stored is secured in the hard disk 33a, the server 10 may refer to the use restriction information 41 contained in the encrypted contents file with a top priority, which is saved in the CD-ROM 33b.

It should be noted that a memory card, a flexible magnetic disk, a CD-R (Compact Disk Recordable), a CD-RW (Compact Disk Rewritable), a DVD (Digital Versatile Disk) are used as a portable storage medium, the user restriction information 41 contained in the encrypted contents file 40 recorded on these portable recording media may be rewritten. Note that when a CD-R is employed, the use restriction information 41 may be rewritten in an additional writing manner.

In the above-described descriptions, at the time instant when the user utilizes the contents, if the use mode of these contents is restricted, then the user of the client 30 accesses the server 10, and then, performs the procedure capable of using the contents after the user has paid the use fee.

Alternatively, while the user of the client 30 is previously connected to the server 10 and pays a use fee as to a desirable use mode, the desirable contents may be used and the use restriction information may be rewritten. Thereafter, when the user executes this use mode, the process operation using the contents may be immediately carried out.

In particular, at the display step (S63) of the use restriction list, a position on the display screen is clicked where a desirable use item is displayed, or a check is made on a check button indicated on the display screen and then an access button on the display screen is clicked, so that the process operation may be immediately progressed to the process operation defined at the step S67.

As previously explained, the user may pay the consideration as to only such contents 42 which are wanted to be used among the contents contained in the encrypted contents data 40 which have been previously downloaded. The user may pay the consideration at the time when the desirable content is actually utilized, or may pay in advance such a consideration. Alternatively, such contents which are wanted to be used may be freely added. When the user accesses the server 10, the user merely receives the rewriting approval of the user restriction information. As a result, the user need not download the entire portion of the encrypted contents file every time the user accesses the sever 10, so that the time required to be connected to the server 10 may be shortened.

In the above-explained description, the music data having the variety is limitedly employed as the multimedia contents. However, the present invention is not limited to the above case. That is, even when contents are made by combining only still image data, moving image data, and character data with each other, or contents are made of a single medium, a use restriction is made as to a portion of these contents in accordance with an intention of a right holder of these contents. Moreover, the user may merely pay a consideration with respect only to such contents 42 which are wanted to be used.

Next, while map data is exemplified as another example, a description will be made of both a use restricting method of contents and a use allowing method thereof.

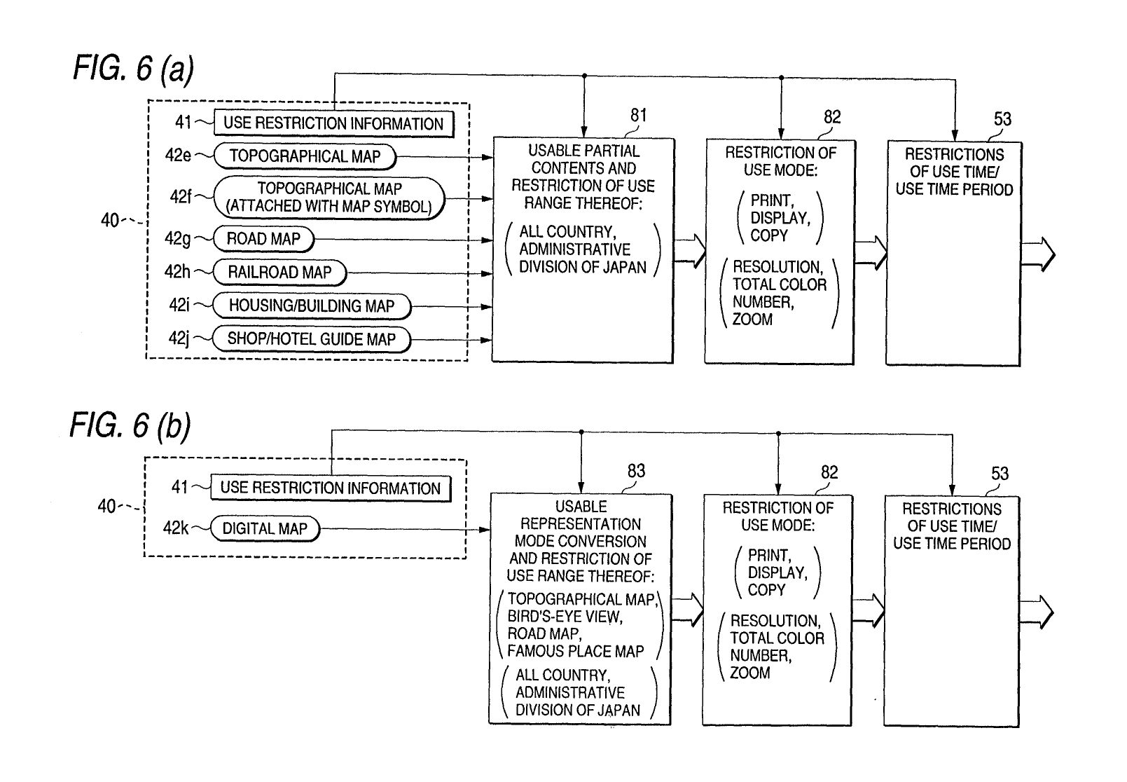

FIG. 6 is a block diagram for explaining a use restriction of contents and a use permission thereof, while map data is exemplified.

FIG. 6A shows such a case that contents are actually constituted by a plurality of partial contents. In this example of the map data, the contents 42 shown in FIG. 1 is arranged by a topographical map 42e, a topographical map (attached with map symbol) 42f, a road map 42g, a railroad map 42b, a housing/building map (attached with indications of resident name, building name, and tenant name) 42i, a shop/hotel guide map 42j (namely, clickable map in which guide screen is displayed when display positions of shop and hotel are clicked), and the like.

In blocks 81, 82, and 53, use restrictions and use permissions of different categories are carried out. There are some possibilities that no restriction is carried out in each of these blocks.

In the block 81, usable partial contents are restricted from six partial contents. With respect to the respective partial contents, use ranges thereof are independently restricted. A use range implies such a range restriction that when an area is subdivided based on a geographical range, these subdivided areas correspond to an entire area of Japan, and the administrative divisions of Japan. In the case that no restriction is made in a geometrical area, the entire area of Japan is defined. In order to restrict the use range, a region should be defined by way of such a data structure that subdivided regions may be discriminated based on latitude/longitude, and regional numbers. Alternatively, each of these partial contents 42e to 42j may be set as partial contents in which each partial content itself is further subdivided into a plurality of regional areas.

In the block 82, use modes are separately restricted with respect to each of these partial contents. In this case, as a use mode, there are provided a print mode, a display mode, and a copy mode. More precisely speaking, there are provided resolution, a total color number, a zooming mode (arbitrary portion is displayed in enlarge mode), and a screen size.

The block 53 is similar to the restrictions of the use time and the use time period as indicated in FIGS. 3A and 3B, so that explanations thereof are omitted.

FIG. 6B indicates such a case that even when only one content is employed, this single content is utilized as such a content having plural different sorts of representation modes while being used.

Even in such a case that the contents 42 corresponds to only a digital map 42k, representation modes which may be utilized in the block 83 may be converted. In this case, a digital map implies that all of map information forming materials are digitally processed. A plurality of contents whose representation modes have been converted from this digital map 42k may constitute such contents that methods of providing information with respect to the user are different from each other.

For instance, a topographical map is formed by employing both topographic data and geographic data, which are contained in the digital map 42k. When altitude information contained in the digital map 42k, a contour line may be displayed. A bird's -eye view may be represented as a quasi-three-dimensional representation by employing this altitude information. A roadmap is formed by using road information contained in the digital map 42k. A famous (interest) place map is formed by using the road information, railroad information, and famous place information, which are contained in the digital map 42k. Similar to the block 81 of FIG. 6A, use ranges may be independently restricted with respect to the respective partial contents.

Since both a block 82 and the block 53 are similar to those of FIG. 6A, explanations thereof are omitted. In FIG. 6A, the digital map is defined as the contents 42k. Alternatively, while all of the map information forming materials are stored in the file forms as the independent layer images of sorts of these material contents, for example, a topographic map, a topographic map attached with map symbols, a roadmap, and a building map are stored as independent files, different contents may be produced by synthesizing a plurality of layer images in response to the display mode.

In the above-explained embodiment, the personal computer is employed as the client. However, even when both the Internet connection function and the Web browser function are employed in an electronic musical instrument itself, the present invention maybe applied.

The present invention may be similarly applied to such a mobile telephone terminal, a fixed-type telephone equipped with a display device, a television, a game machine, and a personal digital Assistant (PDA) which are connectable with the Internet and are operable with the Web browser.

In particular, when music information is employed as the contents, the present invention may be applied to such a case that a call receiving melody is distributed. While a news program, a talk program, and background music (BGM) thereof may be combined with each other as one set, this set may be distributed.

As apparent from the above-described explanations, the following effect may be achieved. That is, while the user can utilize the contents within such a range that the right holder for these contents allows to use the contents, the user can arbitrarily determine the use range of the contents which are purchased.

Furthermore, there is another effect that even after the use permission of the contents has been once set, since this contents use permission may be again set, the user may additionally purchase the contents.

The following effect may be achieved. That is, in the contents which are constituted by a plurality of partial contents related to each other, while all of the partial contents containing such a partial content which is not yet purchased are supplied in advance to the client, when the contents use request is issued from the user, the use allow range may be merely set, and also, this content is not newly supplied to the client.

What is claimed is:

1. A contents providing service system for providing a contents file from a server apparatus to a client apparatus, wherein:
the contents file corresponds to a file including contents and use restriction information which are encrypted, and the use restriction information indicates a use prohibit range of the contents, a use allow range of the contents and a provisional use prohibit range in which allowing a utilization of the contents file is conditional on a user fee payment;
the server apparatus includes a supply unit for supplying the contents file to the client apparatus; and
the client apparatus includes: a decode unit for decoding the contents and the use restriction information, which are contained in the contents file supplied from the server apparatus; and a contents use restriction unit for allowing a utilization of the contents based on the decoded use restriction information.

2. A contents providing service system according to claim 1, wherein
the client apparatus includes a use request unit for transmitting, to the server apparatus, a use request for requesting a use of the contents contained in the provisional use prohibit range;
the server apparatus includes a use approve unit for transmitting a use approval to the client apparatus when a use fee responding to the use request is paid in response to the user request; and
the use restriction unit of the client apparatus allows to use the contents which are requested to be used in accordance with the use approval.

3. A server apparatus for supplying a contents file to a client apparatus, wherein
the contents file corresponds to a file including contents and use restriction information which are encrypted, and the use restriction information indicates a use prohibit range of the contents, a use allow range of the contents and a provisional use prohibit range in which allowing a utilization of the contents file is conditional on a user fee payment;
the server apparatus includes a supply unit for supplying the contents file to the client apparatus; and
the server apparatus allows the client apparatus to use the contents based on the use restriction information.

4. The server apparatus according to claim 3, wherein the contents include a plurality of partial contents which are mutually related to each other; and
the use restrict information represents the use prohibit ranges of the plurality of partial contents, the use allow ranges thereof, and the provisional use prohibit ranges thereof.

5. The server apparatus according to claim 3, wherein
the contents include a plurality of representation modes; and
the use restriction information represents the use prohibit ranges of the plurality of representation modes, the use allow ranges thereof, and the provisional use prohibit ranges thereof.

6. The server apparatus according to claim 3, wherein
the server apparatus includes a use approve unit for receiving a use request for requesting a use of the contents contained in the provisional use prohibit range from the client apparatus, and for transmitting a use approval to the client apparatus when a use fee responding to the use request is paid in response to the user request; and
the server apparatus allows the client apparatus to use the contents which are requested to be used in accordance with the use approval.

7. The server apparatus according to claim 3, wherein
the contents correspond to music information.

8. A contents supplying method for providing a contents file from a server apparatus to a client apparatus, wherein the contents file corresponds to a file including contents and use restriction information which are encrypted, and the use restriction information indicates a use prohibit range of the contents, a use allow range of the contents and a provisional use prohibit range in which allowing a utilization of the contents file is conditional on a user fee payment, the contents supplying method comprising the steps of:
supplying the contents file to the client apparatus; and
allowing the client apparatus to use the contents based on the use restrict information.

9. The contents supplying method according to claim 8, wherein
the contents include a plurality of partial contents which are mutually related to each other; and
the use restrict information represents the use prohibit ranges of the plurality of partial contents, the use allow ranges thereof, and the provisional use prohibit ranges thereof.

10. The contents supplying method according to claim 8, wherein
the contents include a plurality of representation modes; and
the use restriction information represents the use prohibit ranges of the plurality of representation modes, the use allow ranges thereof, and the provisional use prohibit ranges thereof.

11. The contents supplying method according to claim 8, wherein the contents supplying method comprises the steps of:
receiving a use request for requesting a use of the contents contained in the provisional use prohibit range from the client apparatus;
transmitting a use approval to the client apparatus when a use fee responding to the use request is paid in response to the user request; and
allowing the client apparatus to use the contents which are requested to be used in accordance with the use approval.

12. The contents supplying method according to claim 8, wherein
the contents correspond to music information.

13. A client apparatus for utilizing a contents file supplied from a server apparatus, wherein
the contents file corresponds to a file including contents and use restriction information which are encrypted, and the use restriction information indicates a use prohibit range of the contents, a use allow range of the contents and a provisional use prohibit range in which allowing a utilization of the contents file is conditional on a user fee payment;
the client apparatus includes:
a decode unit for decoding the contents and the use restriction information, which are contained in the contents file supplied from the server apparatus; and
a contents use restriction unit for allowing a utilization of the contents based on the decoded use restriction information.

14. The client apparatus according to claim 13, wherein
the contents include a plurality of partial contents which are mutually related to each other; and
the use restrict information represents the use prohibit ranges of the plurality of partial contents, the use allow ranges thereof, and the provisional use prohibit ranges thereof.

15. The client apparatus according to claim 13, wherein
the contents include a plurality of representation modes; and
the use restriction information represents the use prohibit ranges of the plurality of representation modes, the use allow ranges thereof, and the provisional use prohibit ranges thereof.

16. The client apparatus according to claim 13, wherein
the server apparatus includes a use approve unit for receiving a use request for requesting a use of the contents contained in the provisional use prohibit range from the client apparatus, and for transmitting a use approval to the client apparatus when a use fee responding to the use request is paid in response to the user request; and
the server apparatus allows the client apparatus to use the contents which are requested to be used in accordance with the use approval.

17. The client apparatus according to claim 13, wherein
the contents correspond to music information.

18. A contents utilizing method for utilizing a contents file supplied from a server apparatus, wherein the contents file corresponds to a file including contents and use restriction information which are encrypted, and the use restriction information indicates a use prohibit range of the contents, a use allow range of the contents and a provisional use prohibit range in which allowing a utilization of the contents file is conditional on a user fee payment, the contents utilizing method comprising the steps of:
decoding the contents and the use restriction information, which are contained in the contents file supplied from the server apparatus; and
allowing a utilization of the contents based on the decoded use restriction information.

19. The contents utilizing method according to claim 18, wherein
the contents include a plurality of partial contents which are mutually related to each other; and
the use restrict information represents the use prohibit ranges of the plurality of partial contents, the use allow ranges thereof, and the provisional use prohibit ranges thereof.

20. The contents utilizing method according to claim 18, wherein
the contents include a plurality of representation modes; and
the use restriction information represents the use prohibit ranges of the plurality of representation modes, the use allow ranges thereof, and the provisional use prohibit ranges thereof.

21. The contents utilizing method according to claim 18, wherein the contents supplying method comprises the steps of:
receiving a use request for requesting a use of the contents contained in the provisional use prohibit range from the client apparatus;
transmitting a use approval to the client apparatus when a use fee responding to the use request is paid in response to the user request; and
allowing the client apparatus to use the contents which are requested to be used in accordance with the use approval.

22. The contents utilizing method according to claim 18, wherein
the contents correspond to music information.

23. A computer readable recording medium on which a contents utilizing program for utilizing a contents file supplied from a server apparatus is recorded, wherein the contents file corresponds to a file including contents and use restriction information which are encrypted, and the use restriction information indicates a use prohibit range of the contents, a use allow range of the contents and a provisional use prohibit range in which allowing a utilization of the contents file is conditional on a user fee payment, the contents utilizing program is used to cause a computer to execute the steps of:
decoding the contents and the use restriction information, which are contained in the contents file supplied from the server apparatus; and
allowing a utilization of the contents based on the decoded use restriction information.

24. The computer readable recording medium according to claim 23, wherein
the contents include a plurality of partial contents which are mutually related to each other; and
the use restrict information represents the use prohibit ranges of the plurality of partial contents, the use allow ranges thereof, and the provisional use prohibit ranges thereof.

25. The computer readable recording medium according to claim 23, wherein
the contents include a plurality of representation modes; and
the use restriction information represents the use prohibit ranges of the plurality of representation modes, the use allow ranges thereof, and the provisional use prohibit ranges thereof.

26. The computer readable recording medium according to claim 23, wherein the contents utilizing program is used to cause a computer to execute the steps of:
receiving a use request for requesting a use of the contents contained in the provisional use prohibit range from the client apparatus;
transmitting a use approval to the client apparatus when a use fee responding to the use request is paid in response to the user request; and
allowing the client apparatus to use the contents which are requested to be used in accordance with the use approval.

27. The computer readable recording medium according to claim 23, wherein
the contents correspond to music information.
